(19) United States
(12) Patent Application Publication
(10) Pub. No.: US 2009/0165487 A1
(43) Pub. Date: Jul. 2, 2009

(54) Refrigerant Compressor

(75) Inventor: Volker Stübler, Graz (AT)

Correspondence Address: COLLARD & ROE, P.C., 1077 NORTHERN BOULEVARD, ROSLYN, NY, 11576, US

(73) Assignee: ACC AUSTRIA GMBH, Furstenfeld (AT)

(21) Appl. No.: 12/086,440

(22) PCT Filed: Dec. 20, 2006
(86) PCT No.: PCT/EP2006/069994

§ 371 Date: Jun. 12, 2008

(30) Foreign Application Priority Data
Dec. 20, 2005 (AT) GM 873/2005

(51) Int. Cl. F25D 21/14; B29C 43/00

(52) U.S. Cl. 62/291; 264/511

(57) ABSTRACT

The aim of the invention is to create a receptacle (4) which is used for evaporating condensed liquid on a small coolant compressor, allows the heat generated by the small coolant compressor to be utilized in an optimal way, and is easy and inexpensive to produce and mount on the compressor housing. The aim is achieved by embodying the receptacle (4) as a plastic part that is deep-drawn in a receiving device (6) directly on the compressor housing. The plastic part perfectly matches the shape of the receiving device (6) such that the air gap that is usually formed between the compressor housing and the receptacle (4) can be eliminated altogether or reduced to a minimum. A holding element (2) that is arranged on the outer circumference of the cover part (1) ensures optimum support for the receptacle (4), thus dispensing with the need for expensive anti-corrosive measures while the evaporator power and the coefficient of performance (COP) of the small coolant compressor are optimized.

### FIELD OF THE INVENTION

The invention relates to a compressor housing having a cover part and a base part, which encloses a small refrigerant compressor hermetically sealed, a collection container manufactured from plastic being provided on the compressor housing for evaporation of condensed liquid, which is retained in a receptacle implemented on the compressor housing, according to the preamble of Claim 1, and a method for producing and mounting a collection container made of plastic on a compressor housing according to the preamble of Claim 19.

Small refrigerant compressors of this type are predominantly used in the domestic field, where they are typically situated on the back of a refrigerator. Their object is to compress a refrigerant circulating in the cooling system and convey it further, by which heat is removed from the interior of the refrigerator, dissipated to the surroundings, and a refrigerated room or refrigerated shelf is thus cooled.

The refrigerant compressor, which comprises a hermetically-sealed compressor housing, has an electric motor, which drives a piston oscillating in a cylinder via a crankshaft to compress the refrigerant. The compressor housing comprises a cover part and a base part, supply and removal lines being provided, which lead into and out of the compressor housing to convey the refrigerant to the cylinder and therefrom further in the coolant loop.

During the operation of a refrigerator, the fact often proves to be problematic that condensed liquid occurs, in particular ambient moisture condensed because of locally arising lower temperatures, which requires collection in separate collection containers provided for this purpose. These collection containers either have to be emptied regularly, or they ensure sufficient evaporation performance because of suitable implementation and configuration so that condensed liquid is transferred back into the gaseous state and may escape from the area of the small refrigerator.

### PRIOR ART

The collection container is expediently situated in proximity to the compressor housing of the refrigerant compressor, because it represents a heat source and encourages the evaporation of the captured liquid. Collection containers which are implemented as a separate component and are mounted in the area of the refrigerant compressor, for example, via a metal bracket are known from the prior art.

However, collection containers are also known, for example, from U.S. Pat. No. 2,315,222 A or DE 103 22 681 A1, in which the cover part and/or the base part forms a section of the collection container. Through such a design, the heat which is dissipated via the compressor housing may be used nearly directly for evaporating the condensed liquid. However, it also causes a danger of corrosion for the cover part and/or the base part, which are subjected directly to the condensed water in this case and are therefore subject to an accelerated aging process.

For this reason, the possibility suggested itself of using collection containers manufactured from plastic, which have the disadvantage of lower evaporation performance than steel collection containers, however, and cause a lower compressor coefficient of performance (COP), because they exert an undesired heat-insulating effect on the compressor housing as a result of their lower thermal conductivity.

In addition to the lower thermal conductivity of plastic, above all the mounting technique practiced up to this point of the collection containers on the compressor housing of the small refrigerant compressor obstructs optimum heat transfer, because a significant air gap in regard to heat always arises between compressor housing surface and collection container due to the fastening using sleeves, metal brackets, and screw connections.

For example, WO 1999/060317A1 discloses an evaporator shell situated on the cover part of a compressor housing and manufactured from plastic, which has a floor adapted to the surface of the compressor housing and is fastened to the compressor housing double-sided adhesive tapes. The adhesive tapes may be countersunk in small recesses on the surface of the compressor housing. The evaporator shell itself forms a receptacle onto which the cover part of the compressor housing is put.

In general, it may thus be stated that steel collection containers do have a greater evaporator performance and cause a higher compressor coefficient of performance (COP) than plastic collection containers, but because of their susceptibility to corrosion, require greater manufacturing and/or maintenance effort. In contrast, with plastic collection containers, all measures for corrosion protection are dispensed with, the air gap described as a result of the attachment to the compressor housing influencing the evaporator performance and the coefficient of performance (COP) of the compressor disadvantageously, however.

An evaporation device for melt water is known from FR 74 23927, which has a plastic collection container placeable on the compressor housing and adapted to its shape, in which by providing a lower wall thickness of the floor section in relation to the remaining wall sections, a heat-insulating effect of the collection container is to be prevented, however, an air gap formation between compressor housing and collection container also may not be precluded or satisfactorily minimized here. Although the use of thermoplastic materials is provided for this evaporation device, which adapts to the compressor housing at high operating temperatures, in case of such softening of the material, undesired warping of the collection container or even air bubble formation may also occur, because the thermodynamic process resulting in the softening does not occur in a monitored and actively controlled manner. Because the adaptation of the collection container to the compressor housing described first occurs at high operating temperatures, a compressor/evaporation system finished at the factory, which has the required heat conduction specifications from the beginning, thus may not be delivered to the customers.

### DESCRIPTION OF THE INVENTION

It is therefore an object of the present invention to unify the advantages of plastic collection containers with the advantages of steel collection containers and to provide a collection container for evaporating condensed liquid, using which the heat dissipated by the small refrigerant compressor may be optimally used and which may be produced and mounted on the compressor housing easily and cost-effectively. It is to be ensured that small refrigerant compressor and collection container already provide the fixed requirements in regard to evaporation performance and coefficient of performance (COP) when delivered from the factory.

It is a further object of the present invention to suggest a method for the optimized production and mounting of such collection containers on compressor housings.

These objects are achieved according to the invention by a device having the characterizing features of Claim 1 and a method having the characterizing features of Claim 19.

The compressor housing of the small refrigerant compressor, on which the collection container for evaporating condensed liquid is situated, comprises a cover part and a base part which enclose a hermetically-sealed volume with one another, the collection container being manufactured from thermoplastic and the floor of the collection container being adapted to the shape of the cover part of the compressor housing and adjoining it, to allow a good heat transfer from the small refrigerant compressor to the collection container.

According to the invention, the collection container is a plastic part deep-drawn directly on the compressor housing. In that a plastic part is used which obtains its reshaping by a deep-drawing method, which occurs directly on the components of the compressor housing which form a receptacle for the collection container, a precisely fitted adaptation of the collection container to the contact surfaces of the receptacle may be ensured and optimum heat transfer from the compressor housing to the collection container may be achieved.

Because the collection container is subjected to an active exertion of force calibrated to the particular shape of the receptacle during its final shaping and therefore is flexibly adapted to actual instead of hypothetical manufacturing dimensions, an air gap formation between collection container and compressor housing as a result of incalculable, individual manufacturing tolerances may be nearly prevented.

The plastic part produced using a method according to Claim 19, which is described in greater detail and which is molded into the collection container according to the invention, may be a part deep drawn both using conventional mechanical media and also using pressure-impinged fluids or a vacuum.

Because a plastic collection container is provided which is adapted as precisely as possible to the shape of the cover part of the compressor housing in this manner, in addition to the problem of the heat transfer, the corrosion problem described at the beginning is also remedied simply, rapidly, and cost-effectively.

In this manner, complex measures for corrosion protection are dispensed with, which may now be performed efficiently and economically, the evaporator performance and the coefficient of performance (COP) of the small refrigerant compressor being only insignificantly reduced in relation to those for steel collection containers.

According to the characterizing features of Claim 2, the receptacle is formed by at least one retention element, which is preferably manufactured from metallic material, and a section of the surface of the cover part. The retention element has a retention function for the collection container on one hand, and it also performs a cooling rib function on the other hand, in that it continuously dissipates heat from the compressor housing to the surroundings and thus also encourages evaporation of condensed liquid found in the collection container.

According to the characterizing features of Claim 3, the at least one retention element is situated on the cover part, preferably on the outside circumference of the cover part projecting therefrom, and has a shaft-like shape closed around it circumference and open on top. In this manner, a solid enclosure which is simple to manufacture is provided for the collection container.

The at least one shaft-like retention element expediently has a circular, elliptical, or rectangular cross-section according to the characterizing features of Claim 4. Typically, its design corresponds to the shape of the compressor housing, to correspond to its circumference.

To achieve a reduction of the components required for the compressor housing design, a section of the retention element according to the characterizing features of Claim 5 is simultaneously implemented as a sealing connection element of cover part and base part of the compressor housing and is welded onto the compressor housing according to the characterizing features Claim 6. However, the fastening of the retention element on the compressor housing may also be implemented by a screw, solder, or other connection. If the retention element is only attached to the cover part, but is not connected to the base part, an integral embodiment of cover part and retention element in the casting method or deep-drawing method is also conceivable.

To allow material savings during the manufacturing of the retention element, the retention element does not completely enclose the collection container, but rather only on selected sections of its circumference, a toothed shape of the retention element being suggested according to the characterizing features of Claim 7.

Claim 8 discloses a special embodiment variant, the collection container projecting beyond the upper end area of the receptacle. In such a manner, the retention element only encloses the collection container on a partial area of the height of the collection container, in that the retention element is only implemented high enough as is advisable for the cooling rib action and necessary for the retention function.

According to the characterizing features of Claim 9, the collection container has at least one receptacle slot on its side facing toward the cover part, into which the retention element is insertable. The receptacle slot may have a depth which is less than the height of the collection container, preferably less than 50% of the height of the collection container. In this manner, reliable fastening of the collection container to the compressor housing is ensured.

According to the characterizing features of Claim 10, the area of the transition from the retention element to the cover part is additionally provided with a coating, preferably made of plastic or lacquer. In this manner, the areas of the compressor housing especially endangered by corrosion, above all the areas of weld seams and the essentially gap-shaped area between retention element and cover part, are protected separately. Condensed liquid possibly creeping in between collection container and cover part and/or retention element thus may not have harmful effects.

For the case in which more condensed liquid collects in the collection container than it may hold and the heat dissipation of the small refrigerant compressor is inadequate to evaporate the condensed liquid, according to the characterizing features of Claim 11, the collection container also has an auxiliary volume used as an overflow vessel in addition to a main volume. This is separated from the main volume by a web-like wall and/or protrusion, according to the characterizing features of Claim 12, an overflow edge implemented by the web-like wall being situated below the level of a horizontally projected edge of the upper boundary area of the collection container, so that main volume and auxiliary volume form a communicating vessel with one another. A temporary overcapacity of condensed liquid is captured in a reservoir separately provided for this purpose in this manner and then also caused to evaporate.

For an economical construction, the web-like wall is implemented by the area of the collection container with which it is placed on the retention element according to the characterizing features of Claim 13.

The container parts delimiting the main volume and the auxiliary volume may be manufactured integrally according to the characterizing features of Claim 14, in this case, the container part delimiting the auxiliary volume preferably being implemented having a greater wall thickness than the container part delimiting the main volume, to ensure sufficient stability, because the container part delimiting the auxiliary volume is typically situated freely suspended and without further support on the exterior side of the retention element (see FIG. 9).

In a further embodiment variant according to the characterizing features of Claim 15, the container parts delimiting the main volume and the auxiliary volume of the collection container are manufactured as separate parts, which correspond to one another in the form of their contact surfaces in the mounted state. The container part delimiting the auxiliary volume is preferably manufactured as a deep-drawn part made of plastic for this purpose. To provide a reliably sealing and loadable connection element, the container part delimiting the auxiliary volume of the collection container may be injected on the peripheral end area of the collection container using thermoplastic methods according to the characterizing features of Claim 16.

To allow escape of air which is located in an intermediate space of cover part of the compressor housing and collection container during the deep-drawing procedure, the retention element is provided with holes according to the characterizing features of Claim 17. The same holes are additionally used to prevent corrosion on the compressor housing as a result of condensed ambient humidity or overflow liquid creeping into the intermediate space.

According to the characterizing features of Claim 18, polyethylene terephthalate (PET) or polyamide (PA) or polybutylene terephthalate (PBT, PBTP) or thermoplastic polyurethane (TPU) capable of deep drawing may be used as materials for the collection container.

Claim 19 suggests a special method for producing and mounting a collection container made of plastic on a compressor housing according to one of the preceding claims, to reduce the extent of an air gap formation between collection container and compressor housing or retention element to a minimum or prevent it entirely. The collection container is positioned as a blank on the receptacle of the compressor housing provided for it and subsequently brought into its final mounting shape using force action of a pressure medium, preferably under the influence of heat, so that the section of the collection container located in the receptacle adapts to the shape of the receptacle.

The blank may either be a plastic part prefinished with large tolerances and already approximately corresponding to the fitted object shape of the collection container, or also a more or less deformable, not yet pre-shaped material element, for example, in the form of a plate or a part of a material winding roll. In the latter case, the blank receives its first and simultaneously final reshaping by being pressed onto the receptacle provided for it.

The characterizing features of Claim 20 state that the pressure medium used is a liquid or gaseous medium. The collection container blank is preferably impinged with compressed air, or also with any other fluids such as hot gas or hot liquid, so that the shape of the collection container joins directly and precisely fitted to the adjoining surfaces of the receptacle, i.e., to compressor housing, retention element, and any additional component elements.

Instead of a fluid, according to the characterizing features of Claim 21, however, a deep-drawing plunger may also be used for exerting pressure. A mechanical traction/pressure reshaping using deep-drawing plunger is distinguished by a reshaping procedure having a simpler method, which makes measures for delimiting and sealing the pressure area, as are required if liquid or gaseous media are used, superfluous.

It is correspondingly provided according to the characterizing features of Claim 22 that the shape of the deep-drawing plunger corresponds to the shape of the volume circumscribed by the receptacle, i.e., the mechanical pressure medium and/or the deep-drawing plunger has a positive shape, which fills up the negative shape predefined by the receptacle.

According to an alternative method according to the characterizing features of Claim 23, the collection container is stretched over the open cross-section of the retention element of the receptacle as a blank in film form, while the section of the cover part circumscribed by the retention element and pointing toward the film functions as a deep-drawing matrix. In this case, the cover part preferably guided by the inner wall of the retention element is moved as the pressure medium against the stretched blank in film form, and finally adapts its surface shape thereto, until a reshaping of the blank adapted to the receptacle is achieved. The movement of the cover part may be performed both automatically and also manually.

As a further alternative according to the characterizing features of Claim 24, in the method according to the invention, a partial vacuum medium and/or a vacuum pump may also be used. The vacuum pump is attached via a corresponding intake device to at least one opening of the receptacle, preferably to a section of the retention element having multiple holes, to exert a partial vacuum action on this volume and/or on the collection container after completed sealing of the volume existing between receptacle and collection container. In this manner, the collection container is drawn into the shape of the receptacle and adapted precisely thereto.

According to the characterizing features of Claim 25, the force action of the pressure or partial vacuum medium is performed on the collection container under heat action. This favors simpler plastic deformation of the collection container blank and allows optimum adaptation thereof to the adjoining components. Complete prevention of air gaps between the collection container and its receptacle may thus be ensured in that the cover part is heated up to a temperature which results in plastic softening of the collection container in its edge areas, so that the material of the collection container bonds permanently to the surface of the cover part.

### BRIEF DESCRIPTION OF THE FIGURES

The invention will be explained in greater detail on the basis of an exemplary embodiment. In the figures:

FIG. 1 shows a perspective illustration of a small refrigerant compressor

FIG. 2 shows a small refrigerant compressor from FIG. 1 in a top view

FIG. 3 shows a sectional illustration of the small refrigerant compressor along line A-A from FIG. 2

FIG. 4 shows a view of detail X from FIG. 3

FIG. 5 shows a sectional illustration of the small refrigerant compressor along line A-A from FIG. 2

FIG. 6 shows a view of detail ZX from FIG. 5

FIG. 7 shows a perspective illustration of a special embodiment of the collection container according to the invention

FIG. 8 shows a sectional illustration along plane A from FIG. 7

FIG. 9 shows a sectional illustration along plane A from FIG. 7

FIG. 10 shows a perspective illustration of a small refrigerant compressor having seam sealing

FIG. 11 shows a sectional illustration along plane A from FIG. 7

FIG. 12 shows a perspective illustration of a special embodiment of the collection container according to the invention

### METHODS OF IMPLEMENTING THE INVENTION

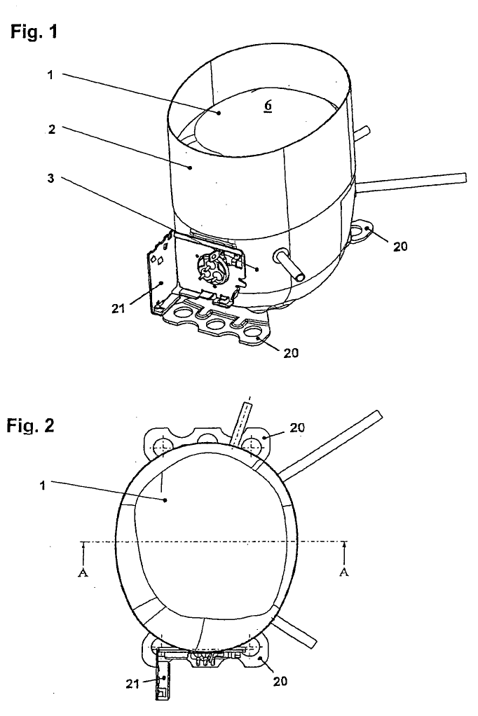

FIG. 1 shows a small refrigerant compressor according to the invention, the compressor housing comprising a base part 3 and a cover part 1, which delimit a hermetically-sealed chamber with one another. A piston-cylinder unit (not shown) is situated in a way known per se in this chamber enclosed by the compressor housing, which is connected to a suction pipe and a pressure pipe, a refrigerant flowing to the piston-cylinder unit via the suction pipe and the pressure pipe leading the refrigerant compressed therein back out of the interior of the compressor housing.

The small refrigerant compressor per se is in turn fastened to a small refrigerator, where it is responsible for the heat dissipation from a cooling chamber of the small refrigerator.

Mounting flanges 20, using which the small refrigerant compressor is fastened to the small refrigerator, and an adapter flange 21, via which the small refrigerant compressor is supplied with electrical energy, are also shown.

As the illustration shows, the upper area of the cover part 1, together with an annular retention element 2 situated on the compressor housing, forms a receptacle 6 into which a collection container 4 made of plastic according to the invention may be inserted.

The heat generated in the interior of the compressor housing is thus transferred to the collection container 4 in this configuration both via the cover part 1, in particular section 16 of the cover part 1, and also via the retention element 2.

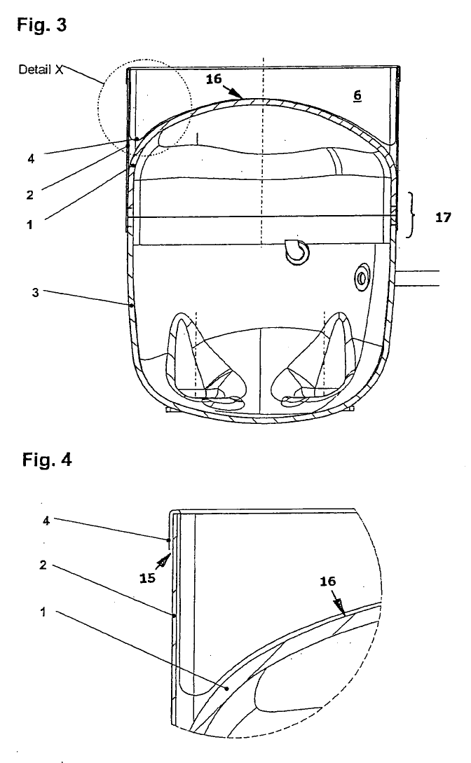

The retention element 2, which is preferably manufactured from steel, may either be situated on the cover part or on the base part 3, but in a preferred construction is preferably positioned as a sealing connection element having a section 17 directly on the contact edges of cover part and base part, where it is usually welded on, to permanently connect the two compressor housing parts to one another (see also FIG. 3 and/or the illustration of the weld seams 8 in FIG. 10). The fastening of the retention element to the compressor housing may also, however, be produced by a screw, solder, or other connection. An integral embodiment of the retention element with the cover or base part in casting or deep-drawing methods is also possible.

The shape of the retention element 2 may vary in accordance with the modeling of the compressor housing and/or the cover part 1, but it will usually be designed as round or oval, the collection container 4 being enclosed annularly along its circumference to ensure a sufficient retention function.

In the construction variant shown, the retention element 2 is implemented as cylindrical and is situated having an axis in the vertical direction, viewed in relation to the stand space and/or the mounting flanges 20 of the compressor housing, to thus be able to be centered and mounted easily on the compressor housing.

From the aspect of a material reduction, it may also be advisable for the collection container 4 not to be continuously enclosed along its circumference by the retention element 2, but rather only to be enclosed partially, for example, in a crenellated or toothed form, but also in other arbitrary forms.

In addition to the retention function, the retention element 2, in particular in a metallic embodiment, also has a heat-transfer function for the collection container 4, because it continually dissipates heat from the compressor housing to the surroundings and thus also to the adjoining collection container 4 as a result of its cooling rib function and thus forces evaporation of condensed liquid located in the collection container 4. The collection container 4 is thus “heated” not only via its floor, but rather also via its side walls.

To further increase the cooling rib effect of the retention element 2, its wall, as shown in FIG. 12, may also be provided with shaft-like cavities 18. The cavities 18 expediently extend through the entire longitudinal cross-section of the retention element 2, favor convective upward flow of air, and thus encourage the dissipation of heat from the compressor housing to the surroundings. The cavities 18 may be provided in an arbitrary number in the retention element 2, the design of their course within the walls of the retention element 2 and the connection of the cavities 18 to one another being entirely discretionary.

The collection container 4 deep-drawn directly on the compressor housing according to the invention is positioned as shown in FIG. 3 on the receptacle 6 formed by a section 16 of the cover part 1 and the retention element 2, in which it adapts exactly after application of the production and/or mounting method described below, so that only a minimal air gap remains between cover part 1 and collection container 4, which only reduces the evaporator performance and the coefficient of performance (COP) of the small refrigerant compressor insignificantly.

The shape of the collection container 4 is adapted precisely to the surface profile of the compressor housing, in particular the section 16 of the cover part 1. The cover part 1 usually has a convex bulge predefined, but also may have arbitrary other specific shapes for acoustic or other technical reasons, to which the shape of the collection container 4 is to be adapted.

The plastic part referred to hereafter as a blank 4, from which the collection container 4 is molded, may be positioned on the receptacle 6 in gradually differing preprocessed states.

The blank 4 may be a prefinished plastic part already mass-produced having a negative tolerance, so that it already essentially corresponds to the shape of the receptacle 6 in which it is inserted for further mounting, or also an entirely non-molded plastic part, which first receives its initial and final usage shape through a corresponding reshaping method during the mounting on the compressor housing. A plate or a film may be cited as an example of an entirely non-molded plastic part or blank 4. Above all, a blank 4 used in film form offers, in addition to its advantage of special adaptability, the advantage of low space requirement during the material transport, because the film may be transported as a separable endless material in wound or folded form especially easily.

The blank 4 may also be a combination of prefinished and non-molded plastic parts, for example, in that a film surface is provided with a reinforced, bead-like edge element, this bead-like edge element being placed on the retention element 2 of the receptacle 6 to offer a reinforced buttress during the reshaping method. In particular, this bead-like edge element may have a receptacle slot 15, into which the retention element 2 is insertable.

Preferably, polybutylene terephthalate (PBT, PBTP), thermoplastic polyurethane (TPU), polyethylene terephthalate (PET), polypropylene (PP), or polyamide (PA) are used as materials for the collection container 4, because they have proven themselves in the production and/or mounting methods according to the invention by their special plastic properties and their strength characteristic values.

In the method according to the invention, the collection container 4 is now inserted as a blank 4 in the receptacle 6 and subsequently brought into its final mounting shape using force action of a pressure or partial vacuum medium.

Both liquid or gaseous media such as compressed air or water and also mechanical pressure media such as deep-drawing plungers, stamps, or matrices come into consideration as the pressure medium used.

If liquid or gaseous media are used as the pressure medium, the volume area of the receptacle 6 provided is preferably impinged with high gases or liquids after completed delimitation and sealing of the pressure area by suitable measures, so that the shape of the collection container 4 joins directly and precisely fitted on the adjoining surfaces of the receptacle 6, i.e., on the compressor housing, retention element 2, and any additional component elements such as screw connections or catches.

If mechanical pressure media are used, it is advantageous to provide them not as entirely rigid, but rather as elastic elements at least at the point of their working contact surface, their elasticity not exceeding that of the collection container material to be molded, however. In such a manner, a flexible adaptation of the collection container 4 to the surface shape of the receptacle 6 is made possible while simultaneously ensuring that the collection container 4 is not damaged during the deep-drawing procedure. The shape of the deep-drawing plunger will correspond to the shape of the volume circumscribed by the receptacle 6.

A favorable possibility for adapting the collection container and/or blank 4 to the shape of the receptacle 6 without using external pressure media is to use the cover part 1 itself as the pressure medium, in that previously the collection container 4 is stretched as a blank in film form over the open cross-section of the retention element 2 of the receptacle 6, to then move the cover part 1 linearly against the stretched film until the section 16 of the cover part 1 circumscribed by the retention element 2 and pointing toward the film has plastically imparted its final form to the film. The stretching of the film on the retention element 2 is caused using typical measures for clamping, for example, by collars or suitable punctual clamping. While the cover part 1 including retention element 2 acts as a deep-drawing matrix, it preferably experiences its guide on the inner wall of the retention element 2. The shaping movement of the cover part 1 may be performed both automatically and also manually, the retention element 2 being rigidly fixed by a suitable retention device.

A vacuum pump may also be used in the method according to the invention as a further alternative. In this case, the vacuum pump is attached via a corresponding suction device to at least one opening of the receptacle 6, preferably to a section of the retention element 2 having multiple holes 13, to then, after completed sealing of the volume 7 existing between receptacle 6 and collection container 4, exert a partial vacuum action on this volume and/or on the collection container 4. In this manner, the collection container and/or blank 4 is drawn into the shape of the receptacle 6 and adapted precisely thereto. The seal of the partial vacuum area is performed using measures typical in the method, such as a radial peripheral clamp of the edge area of the collection container 4 on the retention element 2. Because the retention element 2 is welded onto the compressor housing in a preferred embodiment, no further measures are typically necessary to seal the connection points of cover part 1 and retention element 2.

In all of the methods described, the reshaping of the collection container and/or blank 4 is expediently performed under external heat action, by which simpler plastic deformation of the collection container and/or blank 4 and optimum adaptation thereof in the receptacle 6 are made possible. In this manner, air gaps which obstruct heat transfer are minimized as much as possible, even complete exclusion of air gaps between the collection container 4 and its receptacle 6 being able to be achieved in that the cover part 1 and/or the collection container 4 is heated up to the softening temperature of the collection container 4, so that it melts in its edge areas, to bond permanently to the surface of the cover part 1.

The collection container 4 may be fastened in the receptacle 6 either by precisely fitted insertion and/or pressing therein or by additional fixing using suitable mechanical fastening parts such as screws, clamps, or catches. The use of temperature-resistant adhesives for fastening purposes is also possible.

As the view of detail X from FIG. 3 shown enlarged in FIG. 4 indicates, the upper protruding edge area of the collection container wall may be wrapped around the retention element 2 to thus implement a receptacle slot 15 and ensure optimum suspension of the collection container 4 in the receptacle 6. Furthermore, the possibility exists of fixing the same wrapped-around edge area of the collection container wall to the retention element 2 rigidly and sealed by heat action or adhesive, so that diffusion of liquid overflowing from the collection container 4 or of condensed vapor into the area between receptacle 6 and collection container 4 is prevented. The retention element 2 may also be provided with holes for the purpose of draining condensed liquid between receptacle 6 and collection container 4.

The receptacle slot 15 shown facing toward the cover part 1, into which the retention element 2 is insertable, may also be produced if necessary by milling, slitting, or another chipless or chip-removing processing method, multiple receptacle slots 15 also being able to be provided in the collection container 4 and the chipless or chip-removing processing preferably occurring in a thickened area of the collection container wall, so that sufficient strength of the area forming the receptacle slot 15 is ensured.

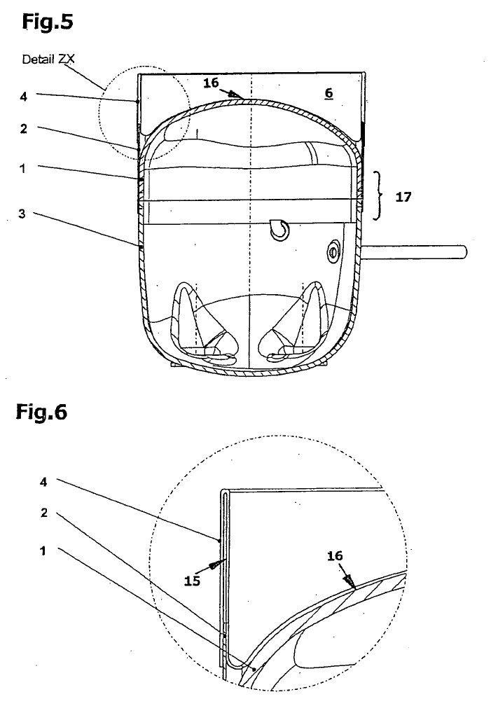

A special embodiment variant is shown in FIG. 5, FIG. 6 showing an enlarged view of detail ZX from FIG. 5. In this case, the retention element 2 and/or the receptacle element 6 only encloses the collection container 4 on a partial area of the height of the collection container 4, in that it is only implemented as high as is advisable for its cooling rib action and required for its retention function. The receptacle slot 15 preferably has a depth which is less than 50% of the height of the collection container 4. To also ensure sufficient rigidity in the area in which the collection container 4 is not directly supported by the retention element 2 because it projects beyond the retention element 2, in the exemplary embodiment shown, the wall of the collection container 4 is folded over at a desired final height of the collection container 4 and led back down into an arbitrary area of the retention element 2, so that the part of the collection container 4 projecting beyond the retention element 2 has a double wall. The measures described above for FIG. 3 and FIG. 4 may again be used as fastening possibilities.

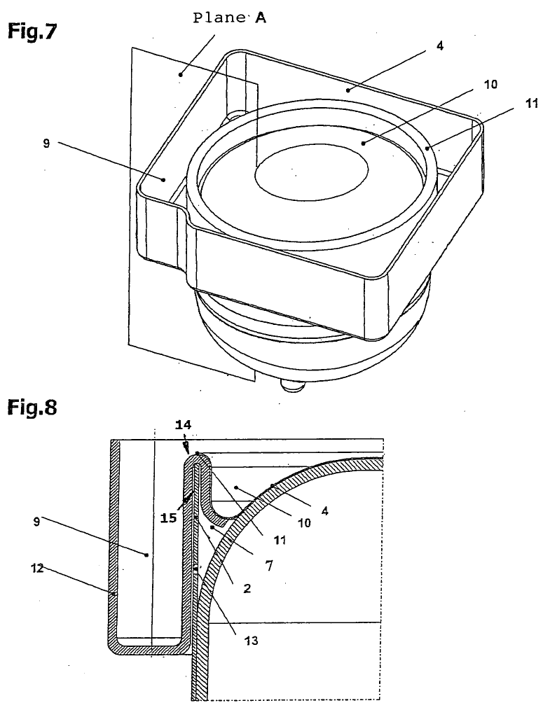

To counteract the danger that more condensed liquid will collect in the collection container 4 than it may hold and it will overflow at an undesired location, the collection container 4, according to the construction shown in FIGS. 7 through 9, also has an auxiliary volume 9 used as an overflow vessel and/or a container part 12 circumscribing this auxiliary volume in addition to the main volume 10. This auxiliary volume 9 is separated from the main volume 10 by a web-like wall 14 having an overflow edge 11, the overflow edge 11 being situated below the level of a horizontally projected edge of the upper edge area of the collection container 4, so that the container parts circumscribing the main volume 10 and the auxiliary volume 9 form a communicating vessel with one another. The web-like wall 14 may either be produced by folding over the collection container wall (as shown) or also by a separate profile parts joined to the collection container 4. The web-like wall 14 is expediently formed by the area of the collection container 4 which is placed on the retention element 2.

Condensed liquid collected in the auxiliary volume 9 is then also caused to evaporate.

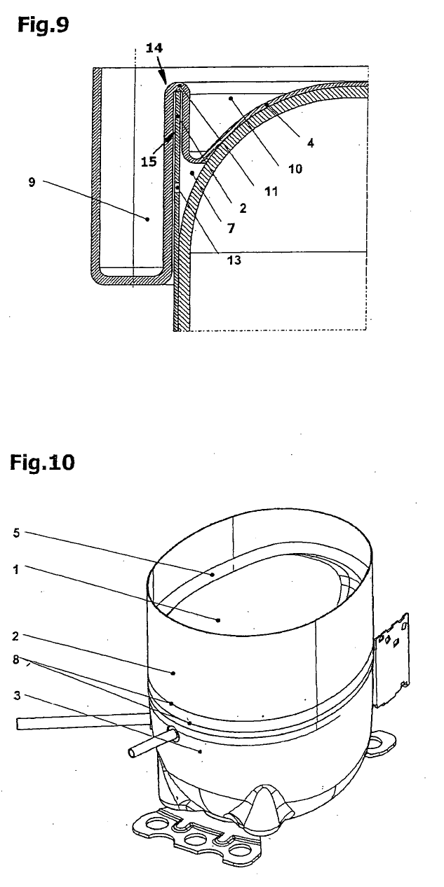

In the case of integral manufacturing of the container parts delimiting the main volume and the auxiliary volume 9 of the collection container 4, the container part delimiting the auxiliary volume 9 is preferably implemented having a greater wall thickness than the container part delimiting the main volume 10 to ensure sufficient stability, because the container part delimiting the auxiliary volume 9 is usually situated freely suspended on the exterior side of the retention element 2 and is additionally subjected to the notch effect of the retention element 2, on which it rests (see FIG. 9).

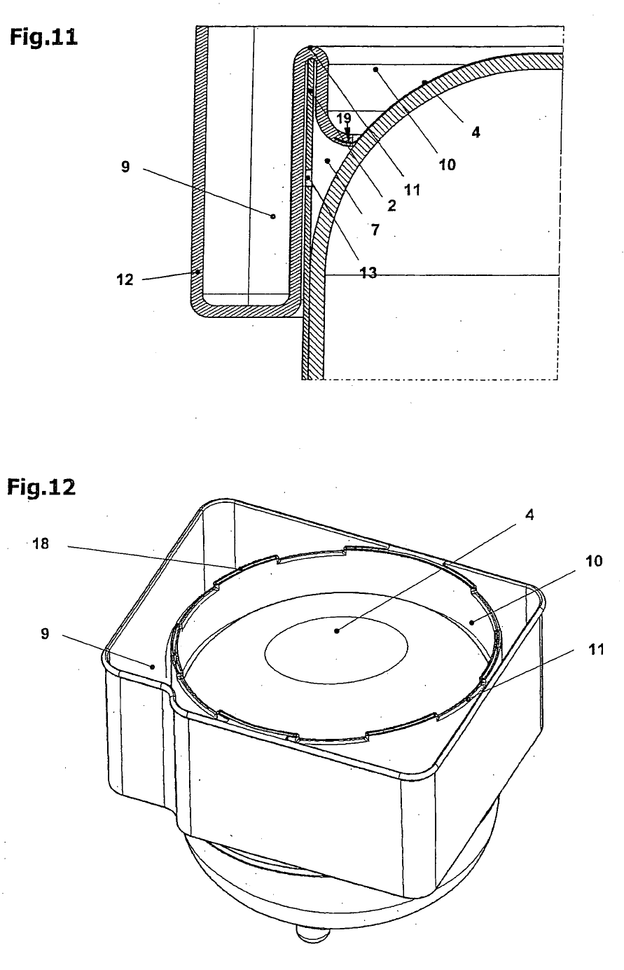

The container parts of the collection container 4 delimiting the main volume 10 and the auxiliary volume 9 of the collection container 4 may also, however, be implemented as separate parts as shown in FIG. 8, which correspond with one another in the shape of their contact surfaces in the mounted state. The container part 12 circumscribing the auxiliary volume 9 is preferably manufactured as a deep-drawn part made of plastic or as a glass-fiber-reinforced injection molded part made of PBT, but may also be implemented from a metallic material. To assemble the two separate parts of the collection container 4 into a reliably sealing composite element which may be loaded with traction, the container part 12 delimiting the auxiliary volume 9 of the collection container 4 is injected using thermoplastic methods on the peripheral end area 19 of the collection container 4, which is preferably implemented in PET film form, and/or extrusion-coated on the peripheral end area 19 of the collection container 4 (see FIG. 11).

To allow an escape of air which is located in an intermediate space 7 of cover part 1 of the compressor housing and collection container 4 during the deep-drawing procedure, the retention element 2 has holes 13.

FIG. 10 shows a further measure to protect especially endangered areas of the compressor housing, above all the areas of the weld seams 8 and the essentially gap-shaped area 5 between retention element 2 and the cover part 1, from corrosion separately. For this purpose, the area 5 of the transition from the retention element 2 and/or the section 17 of the retention element 2 shown in FIG. 5 to the cover part 1 is additionally provided with a coating, this being able to be plastic, a special lacquer, or a metallic coating, for example.

1. A compressor housing having a cover part (1) and a base part (3), which encloses a small refrigerant compressor hermetically sealed, a collection container (4) manufactured from plastic being provided on the compressor housing for evaporating condensed liquid, which is retained in a receptacle (6) implemented on the compressor housing, wherein the collection container (4) is a plastic part deep-drawn directly in its position in the receptacle (6) on the compressor housing.

2. The compressor housing according to claim 1, wherein the receptacle (6) is formed by at least one retention element (2), preferably made of metallic material, and a section (16) of the surface of the cover part (1).

3. The compressor housing according to claim 2, wherein the at least one retention element (2) is situated on the cover part (1), preferably on the external circumference of the cover part (1), projecting therefrom, and has a shaft-like form which is closed along its circumference and open on top.

4. The compressor housing according to claim 3, wherein the least one shaft-like retention element (2) has a circular, elliptical, or rectangular cross-section.

5. The compressor housing according to claim 2, wherein a section (17) of the retention element (2) is implemented as a sealing connection element of cover part (1) and base part (3).

6. The compressor housing according to claim 5, wherein the retention element (2) is welded in the section (17) to the compressor housing.

7. The compressor housing according to claim 2, wherein the retention element (2) is implemented in toothed form on its end area facing away from the cover part (1).

8. The compressor housing according to claim 2, wherein the collection container (4) projects beyond the upper end area of the receptacle (6).

9. The compressor housing according to claim 2, wherein the collection container (4), on its side facing toward the cover part (1), has at least one receptacle slot (15), into which the retention element (2) is insertable, the receptacle slot (15) preferably having a depth which is less than the height of the collection container (4), preferably less than 50% of the height of the collection container (4).

10. The compressor housing according to claim 2, wherein the area of the transition from the retention element (2) to the cover part (1) is additionally provided with a coating, preferably made of plastic or lacquer.

11. The compressor housing according to claim 1, wherein the collection container (4) has, in addition to a main volume (10), an auxiliary volume (9) which is separated from the main volume (10) by a web-like wall (14).

12. The compressor housing according to claim 11, wherein an overflow edge (11) implemented by the web-like wall (14) is situated below the level of a horizontally projected edge of the upper boundary area of the collection container (4).

13. The compressor housing according to claim 11, wherein the web-like wall (14) is implemented by the area of the collection container (4) with which it is placed on the retention element (2).

14. The compressor housing according to claim 11, wherein the container parts delimiting the main volume (10) and the auxiliary volume (9) of the collection container (4) are manufactured integrally, the container part (12) delimiting the auxiliary volume (9) preferably being implemented having a greater wall thickness than the container part delimiting the main volume (10).

15. The compressor housing according to claim 11, wherein the container parts delimiting the main volume (10) and the auxiliary volume (9) of the collection container (4) are manufactured in multiple parts, these container parts preferably overlapping one another and the container part (12) delimiting the auxiliary volume (9) preferably being a deep-drawn part made of plastic.

16. The compressor housing according to claim 15, wherein the container part (12) delimiting the auxiliary volume (9) of the collection container (4) is injected onto the peripheral end area (19) of the collection container (4) using thermoplastic methods.

17. The compressor housing according to claim 1, wherein the retention element (2) is provided with holes (13) to allow escape of air which is located in an intermediate space (7) of cover part (1) of the compressor housing and collection container (4) during the deep-drawing procedure.

18. The compressor housing according to claim 1, wherein the collection container (4) is made of polyethylene terephthalate (PET), polyamide (PA), polypropylene (PP), polybutylene terephthalate (PBT, PBTP), or thermoplastic polyurethane (TPU) which is capable of deep drawing.

19. A method for producing and mounting a collection container made of plastic on a compressor housing according to claim 1, wherein the collection container (4) is positioned as a blank (4) on the receptacle (6) provided for it on the compressor housing and subsequently is brought into its final mounting form using force action of a pressure or partial vacuum medium, so that at least the section of the collection container (4) located in the receptacle adapts to the shape of the receptacle (6).

20. The method according to claim 19, wherein the pressure medium used is a liquid or gaseous medium.

21. The method according to claim 19, wherein the pressure medium used is a deep-drawing plunger.

22. The method according to claim 21, wherein the shape of the deep-drawing plunger corresponds to the shape of the volume circumscribed by the receptacle (6).

23. The method according to claim 19, wherein the collection container (4) is stretched as a blank (4) in film form over the open cross-section of the retention element (2) of the receptacle (6) and the cover part (1) is moved as the pressure medium far enough against the stretched blank (4) in film form that a reshaping of the blank (4) adapted to the receptacle (6) is achieved.

24. The method according to claim 19, wherein the collection container (4) is drawn using a partial vacuum medium and/or a vacuum pump into the shape of the receptacle (6) and adapts thereto as a result of the partial vacuum action.

25. The method according to claim 19, wherein the force action of the pressure or partial vacuum medium on the collection container (4) is performed under the effect of heat.
